(19) United States
(12) Patent Application Publication
(10) Pub. No.: US 2013/0345928 A1
(43) Pub. Date: Dec. 26, 2013

(54) HYBRID ELECTRIC ENVIRONMENTAL CONTROL SYSTEM

(71) Applicants: Dominique P. Sautron, Vernon, CT (US); Carol M. SaNogueira, Milford, CT (US); Evelyn V. Kobialka, Rocky Hill, CT (US)

(72) Inventors: Dominique P. Sautron, Vernon, CT (US); Carol M. SaNogueira, Milford, CT (US); Evelyn V. Kobialka, Rocky Hill, CT (US)

(21) Appl. No.: 13/529,204

(22) Filed: Jun. 21, 2012

(51) Int. Cl. G06F 19/00; B64D 13/00; B64D 41/00

(52) U.S. Cl. 701/36

(57) ABSTRACT

Disclosed is an aircraft environmental control system having interfaces to a first onboard power generation system, interfaces to a second onboard power generation system, and a controller. The controller is operable to distribute power from the first power generation system and the second power generation system to a plurality of aircraft environmental systems, and the controller is operable to switch a subset of the plurality of environmental systems from the first onboard power generation system to the second onboard power generation system.

### BACKGROUND

The present disclosure is directed toward environmental control systems for an aircraft, and more particularly to an electric environmental control system (ECS).

Modern aircraft include multiple environmental systems within the aircraft to facilitate temperature control, pressure control, air circulation and other similar elements within the aircraft cabin. Modern aircraft cabins are further divided into several compartments, each of which can have different environmental requirements. By way of example, different classes of cargo compartment may not be required to have the same levels of pressurization and conditioning as the passenger cabin.

To facilitate control of the varied environmental systems and compartments, an environmental control system (ECS) coordinates and operates all of the environmental systems of the aircraft. In an electric environmental control system, all of the environmental systems are electrically controlled and powered using electric power generated on the aircraft. Current aircraft designs use rotation from fossil fuel powered aircraft engines, such as turbine engines, to turn a rotor in an onboard electric generator, and thereby generate electricity. The electrical requirements to power an Electric ECS vary based on aircraft size and are significantly more than those for a traditional Bleed Air ECS. For a commercial passenger aircraft, the electric ECS can consume up to half or more of the total electricity generated by the engine generator. As is understood by people of skill in the art, any power from the fossil fuel powered aircraft engine that is converted into electricity is necessarily not able to be used for propulsion. Therefore, any reduction in the amount of electricity required to be generated by the generator tied to the fossil fuel powered aircraft results in an increase of power available by the jet engine or an increase in the efficiency of the jet engine.

### SUMMARY OF THE INVENTION

Disclosed is an aircraft environmental control system having interfaces with a first onboard power generation system, interfaces with a second onboard power generation system, and a main controller. The controller is operable to distribute power from the first power generation system and the second power generation system to a plurality of aircraft environmental systems, and the controller is operable to power a subset of the plurality of environmental systems from the first onboard power generation system, and a remainder of the plurality of environmental systems from the second onboard power generation system.

Also disclosed is a method for powering a plurality of environmental control systems having the steps of generating electrical power using a green energy source, generating electrical power using a turbine engine based electrical generator, and controlling a power distribution to a plurality of environmental systems using an environmental control system such that non-essential equipment of the environmental systems are powered by the green energy source and essential equipment of the environmental systems are powered by electrical power generated by the turbine engine based electrical generator.

The various features and advantages of the disclosed examples will become apparent to those skilled in the art from the detailed description. The figures that accompany the detailed description can be briefly described as follows:

### DESCRIPTION OF THE FIGURES

FIG. 1 schematically illustrates an aircraft including an electric environmental control system interfacing with a first onboard power generation system and a second onboard power generation system.

FIG. 2 schematically illustrates an environmental control system for the aircraft of FIG. 1.

### DETAILED DESCRIPTION

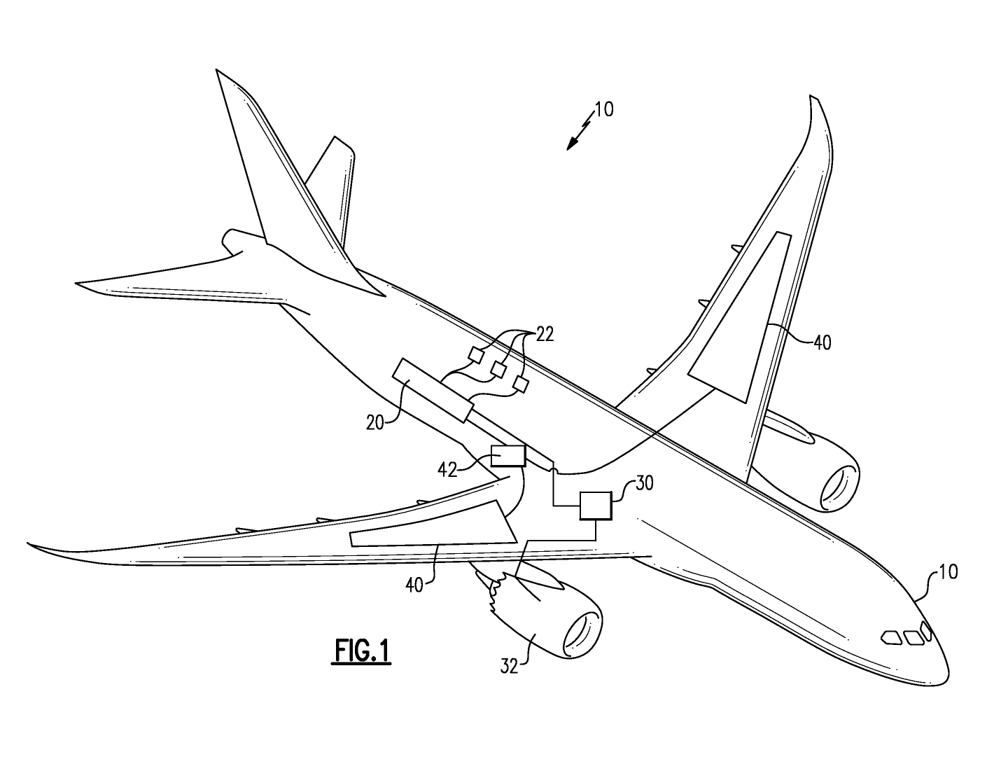

FIG. 1 illustrates an aircraft 10 including an electric environmental control system 20 (EECS). The electric environmental control system 20 controls multiple environmental systems 22 throughout the aircraft 10, and is fully electric. The electric environmental control system 20 receives electric power from an electric generator 32 that within a turbine engine as a first on onboard power generation system. An electric environmental control interface 30 connects the EECS 20 to the generator 32 and allows the EECS 20 to extract power from the first onboard power generation system. Additionally, multiple solar panels 40 are mounted on the wings of the aircraft 10. The solar panels 40 generate secondary power that is likewise provided to the electric environmental system as a second onboard power generation system. An electric environmental control interface 42 connects the EECS 20 to the solar panels 40 and allows the EECS 20 to extract power from the second onboard power generation system. The electric power is used to operate multiple environmental control systems 20, including air compressors for driving air flow and pulling fresh air from outside the aircraft 10. Each of the multiple environmental systems 22 is connected to, and receives power from, one of the electric generator 30 or the solar panels 40 through the electric environmental control system 20.

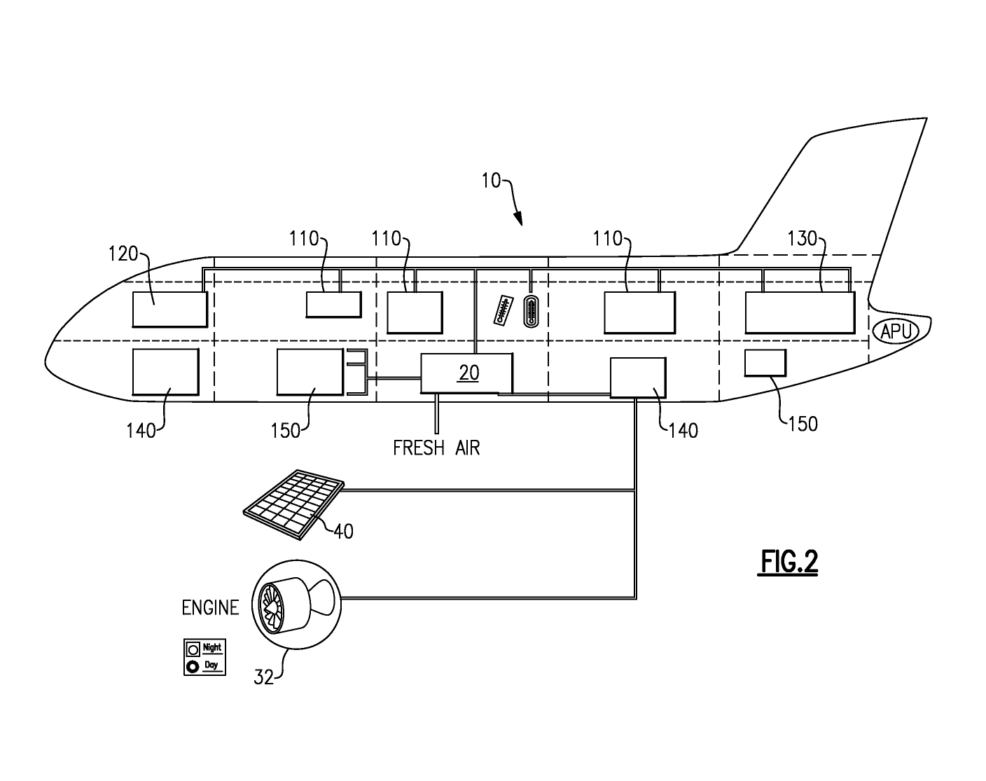

FIG. 2 illustrates an aircraft 10 including environmental systems controlled by the electric environmental control system 20 of FIG. 1 via a controller. The electric environmental control system 20 controls airflow and/or air temperature to multiple passenger compartments 110, a flight deck 120, another crew/miscellaneous compartment 130, avionics/electric equipment bays 140 and various cargo bays 150. Fresh air is drawn from outside the aircraft 10 using electric air compressors and is distributed throughout the aircraft pressurized areas via a ducting network system. As described with regards to FIG. 1, electric power is provided from a generator (referred to as a primary power source) connected to the fossil fuel powered engine 32, and from a green energy source (referred to as a secondary power source) connected to solar panels 40 that are mounted on the aircraft 10.

The power extracted by the ECS 20 and distributed within the environmental systems can be divided into two categories of power extraction: the power serving essential equipment and the power serving non essential equipment. Essential equipment includes equipment tied to air conditioning, pressurization, power electronics cooling, avionics cooling and other electric equipment bay cooling fans. Non-Essential equipment includes equipment tied to air distribution fans, galley fans, cargo fans for cargo compartments that may or may not hold animals. There can be both essential and non essential equipment power extraction within one type of environmental system. For example, the pressurization of cargo can be essential while holding animals meanwhile the auxiliary equipment within the cargo bay such as cargo fans can be non essential if turned off as they may not endanger the occupants. In other words, classification of essential versus non essential equipment is independent of the environmental system it operates in but rather is based on the occupant safety. Essential equipment are equipment that have a bearing on occupant safety if turned off, while non essential equipment are equipment that do not have a bearing on occupant safety if turned off; independent of the environmental system of operation (referred to as ECS Power Distribution network between essential and non essential equipment).

Due to the unpredictable power generation of solar panels 40, and other alternate green energy sources, it is understood that the secondary power supply cannot be relied on to provide constant power at a sufficient level to operate all of the environmental systems 22, and cannot be relied on to power the essential equipment within an environmental system, but can be relied on to power at least part of, if not all of, the non essential equipment within an environmental system.

One example embodiment addresses this issue by using the solar panels 40 to provide at least part of the power to non-essential equipment and uses the primary power source to provide power to the essential equipment and to provide the remainder of the power to the non-essential equipment. In this example embodiment, the primary power source is used to provide power to the environmental systems equipment that is categorized as essential, thereby ensuring that the essential equipment receives power even if the solar panels 40 are generating insufficient power.

In another example embodiment, a battery backup or other electric storage device can be included in the aircraft 10 and provide power for the environmental control systems receiving power from the solar panels 40, or other green power source, in the case that the solar panels 40, or other green power source ceases generating power.

In another, more specific, example the solar panels 40 are used to power non-essential equipment such as air distribution cooling fans, air distribution recirculation fans, galley cooling fans, cargo ventilation fans, and any other equipment that does not impact either passenger or cargo occupant safety when shut off. The primary power source provides power to the essential environmental control system equipment such as cabin pressurization equipment, ram air fans, equipment bay cooling fans, power electronics cooling and avionics cooling.

By providing power to the essential environmental systems equipment using the conventional primary power source, the electric environmental control system 20 ensures that the essential environmental systems equipment is always functional. Using solar panels 40, or another green power source, to power the non-essential environmental systems equipment decreases the amount of energy that must be generated by the primary power source. As the primary power source is required to produce less electricity, less fuel is consumed by the connected jet engine and the emissions of the aircraft are lowered.

In the illustrated example aircraft of FIG. 1, the solar panels 40 are positioned on the wings of the aircraft 10. By positioning the solar panels 40 on the wing, the solar panels 40 can be aligned on the optimum azimuth angle thereby maximizing electric power generated by the solar panels 40. In one example application, the solar panels generate up to 15% of the total electricity requirement of the electric environmental control system 20. While the example aircraft 10 positions the solar panels 40 on the wings, it is understood that alternative solar panel locations can also be utilized.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

We claim:

1. An aircraft comprising:
a first environmental control system interface with a first onboard power generation system;
a second environmental control system interface with a second onboard power generation system; and
a controller connected to said first environmental control system interface and said second environmental control system interface, said controller operable to distribute power from said first power generation system and said second power generation system to a plurality of aircraft environmental systems, wherein said controller is operable to power a subset of said plurality of environmental systems from said first onboard power generation system, and a remainder of said plurality of environmental systems from said second onboard power generation system.

2. The aircraft environmental control system of claim 1, wherein said first onboard power generation system is a solar panel, and said second onboard power generation system is a turbine engine generator.

3. The aircraft environmental control system of claim 1, wherein said plurality of aircraft environmental systems includes a set of essential environmental systems equipment and a set of nonessential environmental systems equipment.

4. The aircraft environmental control system of claim 3, wherein said subset of said plurality of environmental systems comprises said set of essential environmental systems equipment.

5. The aircraft environmental control system of claim 1, further comprising a battery backup connected to said second onboard power generation system.

6. The aircraft environmental control system of claim 5, wherein said controller is operable to draw power from said battery backup when said second onboard power generation system is inoperative.

7. The aircraft environmental control system of claim 3, wherein said set of essential environmental systems equipment comprises at least one of cabin pressurization equipment, cabin conditioning equipment, ram air fans, equipment bay cooling fans, power electronics cooling, and avionics cooling equipment.

8. The aircraft environmental control system of claim 3, wherein said set of non-essential environmental systems equipment comprises at least one of air distribution fans, galley fans, and cargo fans.

9. A method for powering a plurality of environmental control systems comprising the steps of:
extracting electrical power from a green energy source via an interface;
extracting electrical power from a turbine engine based electrical generator via an interface; and
controlling a power distribution to a plurality of environmental systems using a environmental control system such that non-essential environmental systems equipment is powered by said green energy source and essential environmental systems equipment is powered by said turbine engine based electrical generator.

10. The method of claim 9, wherein said green energy source is a solar panel.

11. The method of claim 9, further comprising extracting power from a battery backup when said green energy source is inoperative.
